(19) United States
(12) Patent Application Publication
(10) Pub. No.: US 2010/0068613 A1
(43) Pub. Date: Mar. 18, 2010

(54) NON-AQUEOUS ELECTROLYTE SECONDARY BATTERY

(76) Inventor: Masaki Deguchi, Hyogo (JP)

Correspondence Address: MCDERMOTT WILL & EMERY LLP, 600 13TH STREET, NW, WASHINGTON, DC, 20005-3096, US

(21) Appl. No.: 12/516,533

(22) PCT Filed: May 29, 2008
(86) PCT No.: PCT/JP2008/001344

§ 371 Date: May 27, 2009

(30) Foreign Application Priority Data
Nov. 2, 2007 (JP) 2007-286679
May 28, 2008 (JP) 2008-138815

(51) Int. Cl. H01M 2/14

(52) U.S. Cl. 429/129

(57) ABSTRACT

A non-aqueous electrolyte secondary battery includes: a positive electrode including a transition metal oxide capable of absorbing and desorbing lithium ions; a negative electrode capable of absorbing and desorbing lithium ions; a separator; and a non-aqueous electrolyte. A polyamide film or a porous film containing an inorganic oxide is disposed at least between the positive electrode and the negative electrode, and an unsaturated sultone is added to the non-aqueous electrolyte. This can suppress deterioration in the rate characteristics of the non-aqueous electrolyte secondary battery after storage at a high temperature and improve the storage characteristics of the battery, while maintaining the initial rate characteristics of the battery.

### TECHNICAL FIELD

The invention relates to non-aqueous electrolyte secondary batteries. More particularly, the invention mainly pertains to an improvement in the storage characteristics of a non-aqueous electrolyte secondary battery.

### BACKGROUND ART

Non-aqueous electrolyte secondary batteries, in particular, lithium ion secondary batteries, are extensively studied since they can provide high voltage and high energy density. The positive electrode active material for non-aqueous electrolyte secondary batteries is usually a transition metal oxide such as LiCoO₂. Also, the negative electrode active material is typically a carbon material. The separator is commonly a porous sheet made of, for example, polyethylene or polypropylene.

The non-aqueous electrolyte usually includes a non-aqueous solvent and a lithium salt dissolved therein. The non-aqueous solvent is a cyclic carbonic acid ester, a chain carbonic acid ester, a cyclic carboxylic acid ester or the like. The lithium salt is lithium hexafluorophosphate (LiPF6), lithium tetrafluoroborate (LiBF₄) or the like.

In order to further improve the battery performance of non-aqueous electrolyte secondary batteries, various improvements have been made on the positive electrode active material, negative electrode active material, separator, non-aqueous electrolyte, etc.

For example, it has been proposed to provide the surface of a positive or negative electrode active material layer with a coating film containing a resin binder and solid fine particles (inorganic oxide) as a porous protective film (see, for example, Patent Document 1). The porous protective film suppresses separation of the active material from the electrode during the assembly of a battery, re-adhesion of the separated active material to the electrode, etc. This can suppress occurrence of an internal short-circuit of the battery.

It has also been proposed to add an unsaturated sultone, such as 1,3-propene sultone, to non-aqueous electrolyte (see, for example, Patent Document 2). The unsaturated sultone forms a polymer coating film on the surfaces of a positive electrode active material layer and a negative electrode active material layer. The polymer coating film suppresses reductive decomposition reaction of non-aqueous electrolyte, and when the non-aqueous electrolyte secondary battery is stored at a high temperature, the polymer coating film suppresses capacity loss of the battery, gas evolution, and deterioration in load characteristics. Also, the polymer coating film suppresses deposition of metal cations leached from the positive electrode during high temperature storage onto the negative electrode.

### Patent Document 1: Japanese Laid-Open Patent Publication Hei No. 7-220759

### Patent Document 2: Japanese Laid-Open Patent Publication No. 2002-329528

### DISCLOSURE OF THE INVENTION

### Problem to be Solved by the Invention

In the process of research into improving the storage characteristics of non-aqueous electrolyte secondary batteries, the present inventors have noted the techniques of Patent Documents 1 and 2 and examined them. As a result, they have found the followings.

The porous protective film as in Patent Document 1 can suppress the leaching of a positive electrode active material (i.e., transition metal oxide) into non-aqueous electrolyte only in a limited manner. In particular, during high temperature storage, metal cations greatly leach from the positive electrode. The leached metal cations deposit on the negative electrode, thereby increasing the impedance of the negative electrode. Also, the leached metal cations cause the separator to become clogged, thereby causing the rate characteristics of the battery to deteriorate after storage.

Also, the polymer coating film of unsaturated sultone described in Patent Document 2 tends to be formed unevenly inside the non-aqueous electrolyte secondary battery, and impedes the conduction of lithium ions where the film thickness is large. In particular, during the initial high rate discharge, the polymer coating film of unsaturated sultone impedes the conduction of lithium ions, thereby causing the rate characteristics of the battery to deteriorate.

That is, the present inventors have found that the porous protective film of Patent Document 1 and the non-aqueous electrolyte containing an unsaturated sultone of Patent Document 2 both have a problem to be solved, i.e., they cause battery rate characteristics to deteriorate.

An object of the invention is to provide a non-aqueous electrolyte secondary battery which can maintain the initial rate characteristics at a high level over an extended period of time, exhibits very little deterioration in rate characteristics even after high temperature storage, and has excellent storage characteristics.

### Means for Solving the Problem

Based on the above findings, the present inventors have conducted further studies. As a result, they have found that the combination of the two specific features that cause battery rate characteristics to deteriorate can suppress deterioration in battery rate characteristics in an unexpectedly significant manner, thereby providing a desired non-aqueous electrolyte secondary battery. In this way, they have completed the invention.

That is, the invention is directed to a non-aqueous electrolyte secondary battery including: a positive electrode including a transition metal oxide capable of absorbing and desorbing lithium ions; a negative electrode capable of absorbing and desorbing lithium ions; an insulating film disposed between the positive electrode and the negative electrode, the insulating film being a polyamide film or a porous film containing an inorganic oxide; and a non-aqueous electrolyte containing an unsaturated sultone.

The insulating film is preferably formed on at least one of a surface of the positive electrode and a surface of the negative electrode.

The insulating film is more preferably formed on a surface of the positive electrode.

It is preferable to further include a separator that is a porous resin sheet.

It is preferable that the non-aqueous electrolyte contain lithium salts as solutes, and that at least one of the lithium salts is lithium bispentafluoroethanesulfonyl imide.

It is preferable that the non-aqueous electrolyte contains a non-aqueous solvent as a solvent component, and that the non-aqueous electrolyte further contains fluoroethylene carbonate in addition to the non-aqueous solvent.

### EFFECT OF THE INVENTION

The invention can provide a non-aqueous electrolyte secondary battery with excellent storage characteristics. The non-aqueous electrolyte secondary battery of the invention can maintain the initial rate characteristics at a high level over an extended period of time. Also, the non-aqueous electrolyte secondary battery of the invention exhibits very little deterioration in rate characteristics even after high temperature storage.

### BRIEF DESCRIPTION OF THE DRAWING

FIG. 1 is a schematic longitudinal sectional view of the constitution of a cylindrical non-aqueous electrolyte secondary battery in one embodiment of the invention.

### BEST MODE FOR CARRYING OUT THE INVENTION

The non-aqueous electrolyte secondary battery of the invention is characterized in that an insulating film is disposed at least between the positive electrode and the negative electrode, that the insulating film is a polyamide film or a porous film containing an inorganic oxide, and that the non-aqueous electrolyte contains an unsaturated sultone. The other constitutions thereof can be the same as those of conventional non-aqueous electrolyte secondary batteries.

According to the invention, in the non-aqueous electrolyte secondary battery including the aforementioned specific insulating film, an unsaturated sultone is added to the non-aqueous electrolyte to form a polymer coating film of unsaturated sultone on the surface of the positive electrode and/or the negative electrode. This can suppress leaching of metal cations from the positive electrode when the battery is stored at a high temperature, and can thus suppress deterioration in the rate characteristics of the battery after storage, while maintaining the initial rate characteristics of the battery. The reasons for such excellent effect are probably as follows, although they are not yet sufficiently clear.

As stated above, an unsaturated sultone forms a polymer coating film on the surface of the positive electrode and the surface of the negative electrode. Since this polymerization proceeds very quickly, the thickness of the formed polymer coating film tends to become uneven and non-uniform. Where the thickness of the polymer coating film is large, the conduction of lithium ions is impeded.

However, when the insulating film is disposed at least between the positive electrode and the negative electrode, and is in contact with the surface of the positive electrode active material layer and/or the surface of negative electrode active material layer, a polymer coating film of unsaturated sultone is evenly and uniformly formed on the inner faces of the insulating film facing the pores. In addition, the formed polymer coating film does not close the pores. As a result, the conduction of lithium ions is not impeded and lithium ions are smoothly conducted. Thus, the initial rate characteristics are unlikely to deteriorate.

It is also presumed that when the insulating film with the polymer coating film of unsaturated sultone formed on the inner faces facing the pores is present on the surface of the positive electrode active material of the positive electrode, metal leaching from the positive electrode associated with the oxidative decomposition of the non-aqueous solvent in the electrolyte is suppressed. It is further presumed that when the insulating film with the polymer coating film of unsaturated sultone formed on the inner faces facing the pores is present on the surface of the negative electrode active material of the negative electrode, the reduction of metal ions leached from the positive electrode is suppressed due to the polymer coating film inside the insulating film on the surface of the negative electrode active material, and that metal deposition on the negative electrode is suppressed. Therefore, the formation of the polymer coating film of unsaturated sultone can suppress deposition of metal cations leached from the positive electrode during high temperature storage onto the negative electrode surface. As a result, even after high temperature storage, the rate characteristics of the battery hardly deteriorate, so that the storage characteristics of the battery improve.

It should be noted that the use of a separator, which is a porous resin sheet containing no inorganic oxide, in place of the insulating film can not produce the effects of the invention. The insulating film is characterized in that the tortuosity in the film is lower than that of a separator. A porous film containing an inorganic oxide has a tortuosity of approximately 1.3, a polyamide film has a tortuosity of approximately 1.6, and a separator has a tortuosity of approximately 1.9. When the tortuosity is high as in a separator, the pores in the film extending from one side to the other side thereof have low linearity, and the pore structure in the film has many bends and becomes complicated. Thus, the growth of a polymer coating film of unsaturated sultone on the inner faces of the separator facing the pores is suppressed. As a result, no polymer coating film grows in the pores of the separator, and an uneven polymer coating film is formed only on the positive electrode active materials and the negative electrode active materials.

In contrast, the insulating film has a lower tortuosity than a separator. The pores in the film extending from one side to the other side thereof thus have high linearity, and the pore structure in the film has fewer bends. Hence, a polymer coating film of unsaturated sultone grows on the inner faces of the insulating film facing the pores, and the polymer coating film formed is even and uniform. The polymer film does not concentrate on the surface of the positive electrode active material layer and the surface of the negative electrode active material layer.

The non-aqueous electrolyte secondary battery of the invention includes a positive electrode, a negative electrode, an insulating film, and a non-aqueous electrolyte containing an unsaturated sultone. The non-aqueous electrolyte secondary battery of the invention may further include a separator.

The positive electrode includes a positive electrode current collector and a positive electrode active material layer.

The positive electrode current collector can be one commonly used in the field of non-aqueous electrolyte secondary batteries, and examples include sheets and foil containing stainless steel, aluminum, titanium, etc. While the thickness of the sheets and foil is not particularly limited, it is, for example, 1 to 500 μm.

The positive electrode active material layer is formed on one face or both faces of the positive electrode current collector in the thickness direction thereof. It includes a positive electrode active material, and, if necessary, a binder, a conductive agent, etc.

The positive electrode active material includes a transition metal oxide capable of absorbing and desorbing lithium ions. Examples of such transition metal oxides include LiₓCoO₂, Li_{X}NiO₂, LiₓMnO₂, LiₓCO_{y}Ni_{1-y}O₂, LiₓCo_{y}M_{1-y}O_{z}, LiₓNi_{1-y}M_{y}O_{z}, LiₓMn₂O₄, LiₓMn_{2-y}M_{y}O₄ wherein M is at least one selected from the group consisting of Na, Mg, Sc, Y, Mn, Fe, Co, Ni, Cu, Zn, Al, Cr, Pb, Sb, and B, x=0 to 1.2, y=0 to 0.9, and z=2.0 to 2.3. The value x increases/decreases due to charge/discharge. The invention is particularly effective when the positive electrode active material contains Mn, Co, or Ni. These positive electrode active materials can be used singly or in combination of two or more of them.

The binder can be, for example, polyethylene, polypropylene, fluorocarbon resin, or rubber particles. Examples of fluorocarbon resin include polytetrafluoroethylene (PTFE), polyvinylidene fluoride (PVDF), tetrafluoroethylene-hexafluoropropylene copolymer (FEP), and vinylidene fluoride-hexafluoropropylene copolymer. Examples of rubber particles include styrene-butadiene rubber particles and acrylonitrile rubber particles. Among them, a binder containing fluorine is preferable in terms of, for example, enhancing the resistance of the positive electrode active material layer to oxidation. These binders can be used singly or, if necessary, in combination of two or more of them.

The conductive agent can be, for example, carbon black, graphite, carbon fibers, or metal fibers. Examples of carbon black include acetylene black, ketjen black, channel black, furnace black, lamp black, and thermal black. These conductive agents can be used singly or, if necessary, in combination of two or more of them.

The positive electrode active material layer can be formed, for example, by applying a positive electrode mixture paste onto the surface of a positive electrode current collector and drying it. The positive electrode mixture paste can be prepared, for example, by adding a positive electrode active material and, if necessary, a binder, a conductive agent, etc. to a dispersion medium, and mixing them. The dispersion medium can be, for example, dehydrated N-methyl-2-pyrrolidone (NMP).

The negative electrode includes a negative electrode current collector and a negative electrode active material layer.

The negative electrode current collector can be, for example, a sheet or foil containing stainless steel, nickel, or copper. While the thickness of the sheet and foil is not particularly limited, it is, for example, 1 to 500 μm.

The negative electrode active material layer is formed on one face or both faces of the negative electrode current collector in the thickness direction thereof. It includes a negative electrode active material and, if necessary, a binder, a conductive agent, a thickener, etc.

The negative electrode active material can be a material capable of absorbing and desorbing lithium ions, and usable examples include lithium metal, carbon materials, metal fibers, alloys, tin compounds, silicon compounds, and nitrides. Examples of carbon materials include graphites such as natural graphite (e.g., flake graphite) and artificial graphite, carbon blacks such as acetylene black, ketjen black, channel black, furnace black, lamp black, and thermal black, and carbon fibers. These negative electrode active materials can be used singly or in combination of two or more of them.

The binder and the conductive agent can be the same as the binder and conductive agent contained in the positive electrode active material layer. However, in terms of, for example, enhancing the resistance of the negative electrode active material layer to reduction, the use of a binder containing no fluorine is preferable. The thickeners can be, for example, carboxymethyl cellulose.

The negative electrode active material layer can be formed, for example, by applying a negative electrode mixture paste onto the surface of a negative electrode current collector and drying it. The negative electrode mixture paste can be prepared, for example, by adding a negative electrode active material and, if necessary, a binder, a conductive agent, a thickener, etc. to a dispersion medium, and mixing them. The dispersion medium can be, for example, the same as the dispersion medium of the positive electrode mixture paste, and it is also possible to use water or the like.

The insulating film is disposed at least between the positive electrode and the negative electrode. Also, when a separator, which will be described later, is disposed between the positive electrode and the negative electrode, the insulating film is disposed at least between the positive electrode and the separator and/or between the negative electrode and the separator. When no separator is disposed, the insulating film also has the function of insulating the positive electrode and the negative electrode from each other to prevent a short-circuit between the positive electrode and the negative electrode.

The insulating film can be disposed on one face or both faces of at least one selected from the group consisting of the positive electrode, the negative electrode, and the separator in the thickness direction thereof. Among them, it is preferable to dispose the insulating film on one face or both faces of the positive electrode and/or the negative electrode in the thickness direction thereof. That is, when the insulating film is disposed on a separator surface, the inorganic oxide contained in the insulating film may enter the pores in the separator, thereby interfering with the passage of lithium ions therethrough. It is thus preferable to dispose the insulating film on a positive surface and/or a negative electrode surface. With respect to the positive electrode and the negative electrode, it is preferable to dispose the insulating film on both surfaces thereof.

Further, it is more preferable to dispose the insulating film on a surface or both surfaces of the positive electrode in the thickness direction thereof. In the final stage of discharge of a battery, lithium ions decrease significantly near the positive electrode. However, when the insulating film is disposed on the positive electrode surface(s) and the polymer coating film of unsaturated sultone is evenly formed on the inner faces of the insulating film facing the pores, lithium ion conductivity at the interface between the positive electrode and the non-aqueous electrolyte improves. As a result, the decrease in lithium ions is compensated for and deterioration in rate characteristics can be further suppressed.

The insulating film is a polyamide film or a porous film containing an inorganic oxide.

The polyamide film is a porous film composed mainly of a polyamide. The polyamide is not particularly limited and can be any known one, but a wholly aromatic polyamide (aramid resin) is preferable. Examples of wholly aromatic polyamides include para-substituted wholly aromatic polyamides (hereinafter referred to as “para-aramids”) and meta-substituted wholly aromatic polyamides (hereinafter referred to as “meta-aramids”). In particular, a para-aramid is preferable since it has high mechanical strength and is likely to become porous.

A para-aramid can be prepared, for example, by condensation polymerization of an aromatic diamine with amino groups at the para-positions and an aromatic dicarboxylic halide with acyl groups at the para-positions. A para-aramid thus has amide bonds at the para-positions of an aromatic ring or corresponding positions thereof. A para-aramid has a repeating unit such as a 4,4′-biphenylene group, a 1,5-naphthalene group, or a 2,6-naphthalene group.

Examples of para-aramids include poly(paraphenylene terephthalamide), poly(parabenzamide), poly(4,4′-benzanilide terephthalamide), poly(paraphenylene-4,4′-biphenylene dicarboxylic acid amide), poly(paraphenylene-2,6-naphthalene dicarboxylic acid amide), poly(2-chloro-paraphenylene terephthalamide), and paraphenylene terephthalamide/2,6-dichloro-paraphenylene terephthalamide copolymer. These polyamides can be used singly or in combination of two or more of them.

While the thickness of the polyamide film is not particularly limited, it is preferably 0.5 to 50 μm. If the thickness of the polyamide film is less than 0.5 μm, the mechanical strength of the polyamide film becomes low, so the polymer coating film of unsaturated sultone is unlikely to be evenly formed on the inner faces of the polyamide film facing the pores. As a result, during the initial high rate discharge, the conduction of lithium ions may be impeded. On the other hand, if the thickness of the polyamide film exceeds 50 μm, the distance between the positive electrode and the negative electrode disposed on both sides of the polyamide film becomes large due to the thickness of the polyamide porous film, so that the output characteristics may degrade.

Further, in the case of using no separator, the thickness of the polyamide film is preferably 10 to 50 μm, and more preferably 15 to 30 μm. Also, in the case of using a separator, the thickness of the polyamide film is preferably 0.5 to 50 μm, and more preferably 2 to 10 μm.

The porous film containing an inorganic oxide

(hereinafter referred to as simply a “porous film” unless otherwise specified) contains an inorganic oxide and, if necessary, it may further contain a binder, a thickener, etc. It should be noted, however, that the binder does not include a polyamide.

The inorganic oxide can be any known one, but it is preferably an inorganic oxide having good chemical stability while the battery is in use. Examples of such inorganic oxides include alumina, titania, zirconia, magnesia, and silica. It is also preferable to use such an inorganic oxide in powder form. The volume basis median diameter of the inorganic oxide powder is preferably 0.01 to 10 μm, and more preferably 0.05 to 5 μm. These inorganic oxides can be used singly or in combination of two or more of them. For example, two or more inorganic oxides may be mixed to form a monolaminar porous film containing the mixture. Also, two or more porous films each containing a different inorganic oxide may be laminated.

The binder is not particularly limited, and usable examples include resin materials such as fluorocarbon resin, acrylic resin, rubber particles, polyether sulfone, and polyvinyl pyrrolydone. Among them, for example, fluorocarbon resin, acrylic resin, and rubber particles are preferable. Examples of fluorocarbon resin include polyvinylidene fluoride (PVDF) and polytetrafluoroethylene (PTFE). An example of acrylic resin is BM-720H (trade name) available from Zeon Corporation. Examples of rubber particles include styrene-butadiene rubber particles and modified acrylonitrile rubber particles (e.g., BM-500B (trade name) available from Zeon Corporation). These binders can be used singly or in combination of two or more of them.

The thickener is also not particularly limited, and examples include carboxymethyl cellulose (CMC), polyethylene oxide (PEO), and modified acrylonitrile rubber (e.g., BM-720H (trade name) available from Zeon Corporation). It is preferable to use a thickener when PTFE, BM-500B or the like is used as the binder, in order to, for example, adjust the viscosity of the porous film paste that will be described later.

The porous film can be formed, for example, by applying a porous film paste onto a surface of an active material layer of an electrode (positive electrode and/or negative electrode), and drying it. When a separator is disposed between the positive electrode and the negative electrode, the porous film paste can be applied onto one face or both faces of the separator in the thickness direction thereof to form the porous film.

The porous film paste can be prepared, for example, by mixing an inorganic oxide and, if necessary, a binder, a thickener, etc. In this case, they can be mixed, for example, by using a common mixer such as a double-arm kneader. The application method of the porous film paste is not particularly limited, and conventional application methods using, for example, a doctor blade or a die coater may be used. The drying may be done under a reduced pressure. It is also possible to apply the porous film paste onto an almost flat surface of a substrate and dry it to form a porous film in the same manner as described above, and dispose it at a predetermined position inside a battery.

When an inorganic oxide and a binder are used in combination, the amount of the binder used is preferably 1 to 20% by weight, and more preferably 2 to 10% by weight of the total of the inorganic oxide and the binder. When the amount of the binder used is 2 to 10% by weight, the porous film has a good balance of mechanical strength and lithium ion conductivity. If the amount of the binder used is less than 1% by weight, the mechanical strength of the porous film may become low. If the amount of the binder used exceeds 20% by weight, the porous film may become less porous. If the porous film becomes less porous, its lithium ion conductivity may become low.

While the thickness of the porous film is not particularly limited, it is preferably selected from the range of 0.5 to 50 μm. If the thickness of the porous film is less than 0.5 μm, the mechanical strength of the porous film becomes low, and the polymer coating film of unsaturated sultone is unlikely to be evenly formed on the inner faces of the porous film facing the pores. As a result, during the initial high rate discharge, the conduction of lithium ions may be impeded. On the other hand, if the thickness of the porous film exceeds 50 μm, the distance between the positive electrode and the negative electrode disposed on both sides of the porous film becomes large due to the thickness of the porous film, so that the output characteristics may degrade.

Further, in the case of using no separator, the thickness of the porous film is preferably 10 to 50 μm, and more preferably 15 to 30 μm. Also, in the case of using a separator, the thickness of the porous film is preferably 0.5 to 50 μm, and more preferably 2 to 10 μm.

The non-aqueous electrolyte used in the invention can be the same as a non-aqueous electrolyte conventionally used in non-aqueous electrolyte secondary batteries, except that it contains an unsaturated sultone. The non-aqueous electrolyte contains, for example, a supporting salt, a non-aqueous solvent, and an unsaturated sultone. Preferably, the non-aqueous electrolyte contains fluoroethylene carbonate as a solvent component together with the non-aqueous solvent, and also contains the unsaturated sultone. The non-aqueous electrolyte may further contain a benzene derivative if necessary.

The supporting salt can be a lithium salt commonly used in the field of non-aqueous electrolyte secondary batteries. Examples of lithium salts include LiPF6, LiClO₄, LiBF₄, LiAlCl₄, LiSbF₆, LiSCN, LiCF₃SO₃, LiCF₃CO₂, Li(CF₃SO₂)₂, LiAsF₆, lithium lower aliphatic carboxylates, LiCl, LiBr, LiI, borates, and imide salts.

Examples of borates include chloroborane lithium, lithium bis(1,2-benzenediolate(2-)-O,O′)borate, lithium bis(2,3-naphthalenediolate(2-)-O,O′)borate, lithium bis(2,2′-biphenyldiolate(2-)-O,O′)borate, and lithium bis(5-fluoro-2-olate-1-benzenesulfonic acid-O,O′)borate. Examples of imide salts include lithium bistrifluoromethanesulfonyl imide (LiN(CF₃SO₂)₂), lithium trifluoromethanesulfonyl-nonafluorobutanesulfonyl imide (LiN(CF₃SO₂)(C₄F₉SO₂)), and lithium bispentafluoroethanesulfonyl imide (LiN(C₂F₅SO₂)₂).

Among them, lithium bispentafluoroethanesulfonyl imide (hereinafter referred to as “LiBETI”) in particular can serve as a surfactant as well as a lithium salt. Thus, when the non-aqueous electrolyte contains LiBETI, its wettability by the binder contained in the porous film increases. As a result, a local voltage rise is unlikely to occur in the electrodes, and metal leaching from the positive electrode due to oxidative decomposition of the non-aqueous solvent in the non-aqueous electrolyte is suppressed. Also, when LiBETI is reduced at the negative electrode, it forms a good inorganic coating film such as LiF. Such an inorganic coating film can suppress deposition of metal cations leached from the positive electrode onto the negative electrode.

It is therefore preferable to use LiBETI alone or use LiBETI and another lithium salt in combination. Also, in the invention, not only LiBETI but also other lithium salts can be used singly or in combination of two or more of them. The concentration of the lithium salt(s) in the non-aqueous electrolyte can be selected as appropriate, depending on the composition of the non-aqueous solvent, the intended use of the battery produced, etc., but it is, for example, 0.7 to 3 mol/liter.

The non-aqueous solvent can be one commonly used in the field of non-aqueous electrolyte secondary batteries, and examples include unsaturated cyclic carbonic acid esters, cyclic sulfones, saturated cyclic carbonic acid esters (cyclic carbonates), chain carbonic acid esters (non-cyclic carbonates), and cyclic carboxylic acid esters. A saturated cyclic carbonic acid ester is a cyclic carbonic acid ester whose molecule has no carbon-carbon unsaturated bond. An unsaturated cyclic carbonic acid ester is a cyclic carbonic acid ester whose molecule has at least one carbon-carbon unsaturated bond.

An unsaturated cyclic carbonic acid ester decomposes on the negative electrode surface to form a highly lithium-ion conductive coating film, thereby enhancing the coulombic efficiency of the battery. Examples of unsaturated cyclic carbonic acid esters include vinylene carbonate (VC), 3-methyl vinylene carbonate, 3,4-dimethyl vinylene carbonate, 3-ethyl vinylene carbonate, 3,4-diethyl vinylene carbonate, 3-propyl vinylene carbonate, 3,4-dipropyl vinylene carbonate, 3-phenyl vinylene carbonate, 3,4-diphenyl vinylene carbonate, vinyl ethylene carbonate (VEC), and divinyl ethylene carbonate. Among them, vinylene carbonate, vinyl ethylene carbonate, and divinyl ethylene carbonate are particularly preferable since they can form on the negative electrode surface a strong coating film that is unlikely to separate.

The hydrogen atoms contained in an unsaturated cyclic carbonic acid ester may be partly replaced with fluorine atoms. The content of the unsaturated cyclic carbonic acid ester in the non-aqueous solvent is preferably 0.5 to 10% by volume of the total amount of the non-aqueous solvent, in terms of enhancing coulombic efficiency and suppressing an increase in impedance. If it is less than 0.5% by volume, the addition of the unsaturated cyclic carbonic acid ester may not be sufficiently effective. Also, if it is significantly higher than 10% by volume, an excessive coating film is formed, which may result in increased impedance.

Also, a sulfolane is highly resistant to oxidation, and is thus believed to further improve the high temperature storage characteristics of the battery. Among cyclic sulfolanes, in terms of improving the high temperature storage characteristics of the battery, sulfolane is particularly preferable. Examples of sulfolane compounds include sulfolane (SL) and 3-methylsulfolane (3MeSL).

Examples of saturated cyclic carbonic acid esters include ethylene carbonate (EC), propylene carbonate (PC), and butylene carbonate (BC). Examples of chain carbonic acid esters include dimethyl carbonate (DMC), diethyl carbonate (DEC), ethyl methyl carbonate (EMC), and dipropyl carbonate (DPC). Examples of cyclic carboxylic acid esters include γ-butyrolactone (GBL) and γ-valerolactone (GVL). Among these non-aqueous solvents, unsaturated cyclic carbonic acid esters and sulfolanes are preferable. These non-aqueous solvents can be used singly or in combination of two or more of them.

In the invention, it is preferable to use fluoroethylene carbonate as a solvent component together with the above-mentioned non-aqueous solvent. Fluoroethylene carbonate has a high wettability by the binder contained in the porous film. Hence, by adding only a small amount thereof to the non-aqueous solvent, a local voltage rise is unlikely to occur in the electrodes, and metal leaching from the positive electrode due to oxidative decomposition of the non-aqueous solvent in the non-aqueous electrolyte is suppressed. Also, when fluoroethylene carbonate is reduced at the negative electrode, it forms a good coating film. Such a coating film suppresses deposition of metal cations leached from the positive electrode onto the negative electrode.

The amount of fluoroethylene carbonate used is preferably 1 to 10 parts by mass per 100 parts by mass of the non-aqueous solvent, and more preferably 2 to 5 parts by mass per 100 parts by mass of the non-aqueous solvent. If the amount used is less than 1 part by mass, the effect of increasing the wettability of the non-aqueous electrolyte by the binder contained in the porous film may be insufficient. If the amount used is significantly higher than 10 parts by mass, the coating film formed on the negative electrode as a result of reduction may become too thick, thereby increasing impedance and resulting in deteriorated rate characteristics.

With respect to the unsaturated sultone, any known one may be used, and examples include 1,3-propene sultone, 2-methyl-1,3-propene sultone, 2-ethyl-1,3-propene sultone, 2-fluoro-1,3-propene sultone, 2,2,2-trifluoro-1,3-propene sultone, 2,4-butene sultone, 1,3-butene sultone, 1,4-butene sultone, and 1,5-pentene sultone. Among them, 1,3-propene sultone is preferable since it has very high polymerization reactivity. These unsaturated sultones can be used singly or in combination of two or more of them.

While the content of the unsaturated sultone in the non-aqueous electrolyte is not particularly limited, it is preferably 0.1 to 10 parts by mass per 100 parts by mass of the non-aqueous solvent. If the unsaturated sultone content is less than 0.1 part by mass, the addition of the unsaturated sultone may not be sufficiently effective. Also, if the unsaturated sultone content exceeds 10 parts by mass, the polymer coating film formed on the electrode surface becomes thick, and for this and other reasons, the electrode reaction between the lithium ions in the non-aqueous electrolyte and the electrodes tends to be impeded so that the absorption and desorption of the lithium ions into and from the electrodes tends to become difficult.

A benzene derivative decomposes, for example, during overcharge to form a coating film on the electrode surface, thus having the function of deactivating the battery. The usable benzene derivative can be a known one containing a phenyl group and a cyclic compound group adjacent to the phenyl group. Examples of cyclic compound groups include a phenyl group, a cyclic ether group, a cyclic ester group, a cycloalkyl group, and a phenoxy group. Examples of such benzene derivatives include cyclohexyl benzene, biphenyl, and diphenyl ethers. They may be used singly or in combination of two or more of them. The benzene derivative content in the non-aqueous electrolyte is preferably 0.5 to 10 parts by volume per 100 parts by volume of the non-aqueous solvent.

The non-aqueous electrolyte secondary battery of the invention may include a separator, as described above. The separator is disposed between the positive electrode and the negative electrode. In the invention, a separator refers to a porous resin sheet containing no inorganic oxide. A separator is thus different from a porous film containing an inorganic oxide.

The resin constituting the separator can be one commonly used in the field of non-aqueous electrolyte secondary batteries, and examples include polyolefins such as polyethylene and polypropylene, polyamides, and polyamide-imides. Examples of forms of such a porous sheet include porous sheet form, non-woven fabric, and woven fabric. Among them, a porous sheet form having a very small internal pore size of usually about 0.05 to 0.15 μm is preferable since it is high in all of ion permeability, mechanical strength, and insulating capability.

Also, the thickness of the separator is not particularly limited, but it can be, for example, 10 to 300 μm in terms of suppressing an excessive increase in impedance.

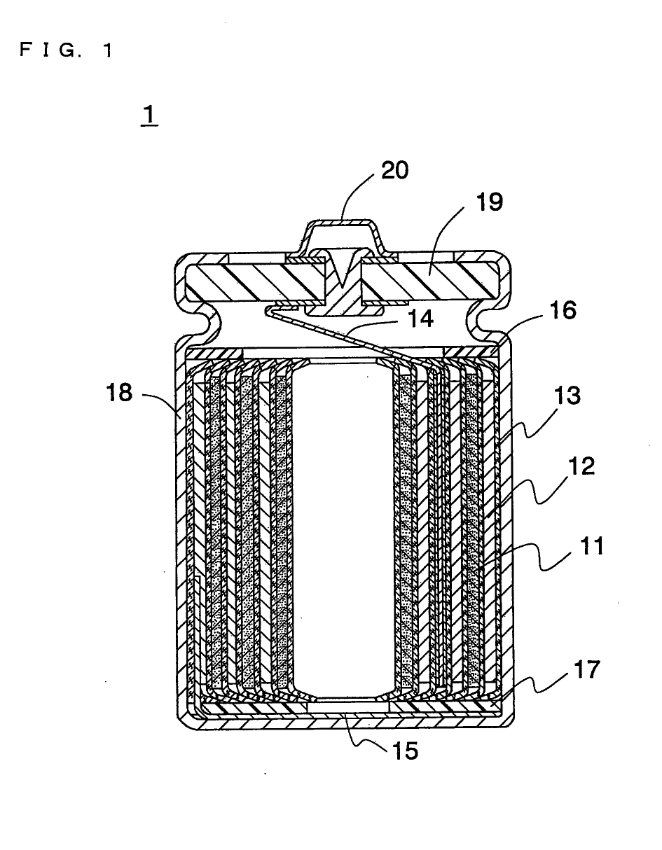

FIG. 1 is a schematic longitudinal sectional view of the structure of a cylindrical non-aqueous electrolyte secondary battery 1 in one embodiment of the invention. The cylindrical non-aqueous electrolyte secondary battery 1 is a wound-type battery including a positive electrode 11, a negative electrode 12, a separator 13, a positive electrode lead 14, a negative electrode lead 15, an upper insulator plate 16, a lower insulator plate 17, a battery case 18, a seal plate 19, a positive electrode terminal 20, and a non-aqueous electrolyte (not shown). A porous film containing an inorganic oxide (not shown) is formed on each side of the positive electrode 11 in the thickness direction thereof. Also, the non-aqueous electrolyte contains an unsaturated sultone.

The positive electrode 11, the negative electrode 12, and the separator 13 are laminated in the order of the positive electrode 11, the separator 13, and the negative electrode 12, and are spirally wound to form a wound electrode assembly. One end of the positive electrode lead 14 is connected to the positive electrode 11, while the other end is connected to the seal plate 19. The material of the positive electrode lead 14 is, for example, aluminum. One end of the negative electrode lead 15 is connected to the negative electrode 12, while the other end is connected to the bottom of the battery case 18 serving as the negative electrode terminal. The material of the negative electrode lead 15 is, for example, nickel.

The battery case 18 is a cylindrical container with a bottom. It has an opening at one end of the longitudinal direction and the bottom at the other end, which serves as the negative electrode terminal. The upper insulator plate 16 and the lower insulator plate 17 are resin components sandwiching the wound electrode assembly from above and below, thereby insulating the wound electrode assembly from the other components. The material of the battery case 18 is, for example, iron. The inner face of the battery case 18 is plated with, for example, nickel. The seal plate 19 is equipped with the positive electrode terminal 20.

The cylindrical non-aqueous electrolyte secondary battery 1 can be produced, for example, as follows. First, the upper insulator plate 16 and the lower insulator plate 17 are fitted to the upper and lower ends of the wound electrode assembly, respectively. In this state, the assembly is placed in the battery case 18. A connection is made by means of the positive electrode lead 14. The negative electrode 12 is connected to the bottom of the battery case 18 serving as the negative electrode terminal by means of the negative electrode lead 15. A non-aqueous electrolyte is then injected into the battery case 18. Further, using the seal plate 19, the opening of the battery case 18 is sealed. In this way, the non-aqueous electrolyte secondary battery 1 can be obtained.

When a porous film containing an inorganic oxide is formed on the surface(s) of the negative electrode or separator, a non-aqueous electrolyte secondary battery can be produced in the same manner as described above.

### EXAMPLES

The invention is hereinafter described specifically by way of Examples and Comparative Examples.

### Example 1

### (1) Preparation of Non-Aqueous Electrolyte

LiPF6 was dissolved in sulfolane at 1 mol/L. This solution was mixed with 2 parts by mass of 1,3-propene sultone (hereinafter abbreviated as “PRS”) per 100 parts by mass of sulfolane, to prepare a non-aqueous electrolyte.

### (2) Separator

A 20 μm-thick micro-porous sheet made of polyethylene (available from Asahi Kasei Chemicals Corporation) was used as the separator.

### (3) Preparation of Positive Electrode

A positive electrode mixture paste was prepared by mixing 85 parts by weight of a lithium cobaltate powder (positive electrode active material, volume basis median diameter 10 μm, available from Tanaka Chemical Corporation), 10 parts by weight of acetylene black (conductive agent, available from Denki Kagaku Kogyo K.K.), 5 parts by weight of polyvinylidene fluoride resin (binder, available from Kureha Corporation), and 40 parts by weight of dehydrated N-methyl-2-pyrrolidone (NMP, dispersion medium). The positive electrode mixture paste was applied onto a positive electrode current collector (thickness 15 μm) made of aluminum foil with a comma coater. The positive electrode mixture was then dried at 120° C. for 5 minutes and rolled to form 160-μm thick positive electrode mixture layers. In this way, a positive electrode was prepared.

### (4) Preparation of Negative Electrode

A mixture of 100 parts by weight of an artificial graphite powder (negative electrode active material, volume basis median diameter 20 μm, available from Hitachi Chemical Company, Ltd.), 1 part by weight of polyethylene resin (binder, available from Mitsui Chemicals. Inc.), and 1 part by weight of carboxy methyl cellulose (thickener, available from Dai-ichi Kogyo Seiyaku Co., Ltd.) was prepared. The mixture was mixed with a suitable amount of water and kneaded to form a negative electrode mixture paste. The negative electrode mixture paste was applied onto a negative electrode current collector (thickness 10 μm) made of copper foil. The negative electrode mixture paste was then dried at 100° C. for 5 minutes and rolled to form 160-μm thick negative electrode mixture layers. In this way, a negative electrode was prepared.

### (5) Preparation of Inorganic-Oxide-Containing Porous Film

A porous film paste was prepared by mixing 97 parts by weight of alumina (inorganic oxide, volume basis median diameter 0.3 μm), 37.5 parts by weight of an NMP solution containing 8% by weight of modified acrylonitrile rubber (binder, trade name: BM-720H, available from Zeon Corporation), and a suitable amount of NMP with a double-arm kneader. The porous film paste was applied at a thickness of 5 μm on the surface of each positive electrode active material layer on each side of the positive electrode, and dried at 120° C. for 10 minutes. The applied coating was further dried at 120° C. under a vacuum for 10 hours, to form porous films. The thickness of each porous film was 5 μm.

### (6) Production of Cylindrical Battery

Using the positive electrode with the porous films on both sides, the negative electrode, the separator, and the non-aqueous electrolyte prepared in the above manner, the cylindrical non-aqueous electrolyte secondary battery 1 as illustrated in FIG. 1 was produced.

The positive electrode 11, the separator 13, and the negative electrode plate 12 were laminated in this order, and spirally wound to form a wound electrode assembly. The upper insulator plate 16 was fitted to the upper part of the wound electrode assembly, and the lower insulator plate 17 was fitted to the lower part thereof. This was placed in the iron battery case 18 whose inner face was plated with nickel. One end of the aluminum positive electrode lead 14 was connected to the positive electrode 11, while the other end was connected to the backside of the seal plate 19 electrically connected to the positive electrode terminal 20. One end of the nickel negative electrode lead 15 was connected to the negative electrode 12, while the other end was connected to the bottom of the battery case 18. Subsequently, a predetermined amount of the non-aqueous electrolyte was injected into the battery case 18. The open edge of the battery case 18 was crimped onto the seal plate 19 to seal the opening of the battery case 18. In this way, a cylindrical non-aqueous electrolyte secondary battery of the invention was produced.

### (7) Battery Evaluation

### [Measurement of Initial High-Rate Capacity Retention Rate]

The battery thus produced was charged under the following conditions, and the initial 1 C discharge capacity and 2 C discharge capacity were measured at 20° C. The percentage of the 2 C discharge capacity relative to the 1 C discharge capacity was used as the initial high-rate capacity retention rate. The result is shown in Table 1.

The charge conditions were a constant-current and constant-voltage charge for 2.5 hours at a maximum current of 1050 mA and an upper limit voltage of 4.2 V. The discharge conditions were a constant-current discharge at a discharge current of 1 C (=1500 mA) and a discharge current of 2 C (=3000 mA), and at an end-of-discharge voltage of 3.0 V.

[Measurement of Amount of Metal Deposited on Negative Electrode after High Temperature Storage]

The battery obtained in the above manner was charged. The charge conditions were a constant-current and constant-voltage charge for 2.5 hours at a maximum current of 1050 mA and an upper limit voltage of 4.2 V. The battery was then stored in an environment whose temperature was as high as 85° C. for 72 hours. After the high temperature storage, the battery was disassembled, and the central part (2×2 cm) of the negative electrode was cut out and then cleaned with ethyl methyl carbonate (EMC) three times. An acid was added to the cleaned negative electrode, which was then heated to dissolve the negative electrode. Thereafter, undissolved matter was filtered out, and the filtrate was brought to a constant volume to be used as a measurement sample. The measurement sample was subjected to an ICP emission spectral analysis using an ICP emission spectrometer (trade name: VISTA-RL, available from VARIAN). The amount of metal deposition was determined by converting the amount of Co contained in the measurement sample to an amount per gram of the negative electrode. The result is shown in Table 1.

[Measurement of Capacity Recovery Rate after High Temperature Storage]

The battery was charged and stored at a high temperature in the same manner as described above, and the 1 C discharge capacity of the battery was measured at 20° C. The percentage of the 1 C discharge capacity after the storage relative to the 1 C discharge capacity before the storage was used as the capacity recovery rate after high temperature storage. The result is shown in Table 1.

In the above, the charge conditions were a constant-current and constant-voltage charge for 2.5 hours at a maximum current of 1050 mA and an upper limit voltage of 4.2 V. The discharge conditions were a constant-current discharge at a discharge current of 1 C (=1500 mA) and an end-of-discharge voltage of 3.0 V.

### Example 2

A cylindrical non-aqueous electrolyte secondary battery of the invention was produced and evaluated in the same manner as in Example 1, except that the porous film containing the inorganic oxide was formed on the surface of each negative electrode active material layer on each side of the negative electrode, not the positive electrode. The results are shown in Table 1.

### Comparative Example 1

A cylindrical non-aqueous electrolyte secondary battery was produced and evaluated in the same manner as in Example 1, except that PRS was not added to the non-aqueous electrolyte and that the porous film containing the inorganic oxide was not formed on the surface of each positive electrode active material layer of the positive electrode. The results are shown in Table 1.

### Comparative Example 2

A cylindrical non-aqueous electrolyte secondary battery was produced and evaluated in the same manner as in Example 1, except that the porous film containing the inorganic oxide was not formed on the surface of each positive electrode active material layer. The results are shown in Table 1.

### Comparative Example 3

A cylindrical non-aqueous electrolyte secondary battery was produced and evaluated in the same manner as in Example 1, except that PRS was not added to the non-aqueous electrolyte. The results are shown in Table 1.

### Comparative Example 4

A cylindrical non-aqueous electrolyte secondary battery was produced and evaluated in the same manner as in Example 2, except that PRS was not added to the non-aqueous electrolyte. The results are shown in Table 1.

TABLE 1

| | | | | Amount of | |
|---|---|---|---|---|---|
| | | | Initial | metal | Capacity |
| | | | capacity | deposi- | recovery |
| | | | reten- | tion | rate |
| | | | tion | after | after |
| | | | rate | storage | storage |
| | PRS | Porous film | (%) | (μg/g) | (%) |
| Example 1 | Added | Both surfaces | 95.5 | 6.2 | 86.8 |
| | | of positive | | | |
| | | electrode | | | |
| Example 2 | Added | Both surfaces | 93.0 | 6.4 | 84.0 |
| | | of negative | | | |
| | | electrode | | | |
| Comparative | Not | Not formed | 95.4 | 35 | 52.1 |
| Example 1 | added | | | | |
| Comparative | Added | Not formed | 82.2 | 6.7 | 75.7 |
| Example 2 | | | | | |
| Comparative | Not | Both surfaces | 95.6 | 33 | 53.3 |
| Example 3 | added | of positive | | | |
| | | electrode | | | |
| Comparative | Not | Both surfaces | 95.1 | 35 | 51.9 |
| Example 4 | added | of negative | | | |
| | | electrode | | | |

Table 1 clearly shows that as in Examples 1 and 2, when a non-aqueous electrolyte contains PRS and a porous film containing an inorganic oxide is formed on the active material layer surfaces of a positive electrode or negative electrode, a battery having excellent high-temperature storage characteristics can be obtained. That is, the batteries of the invention have good initial capacity retention rates. Also, even when they are stored at a high temperature, the amount of metal originally contained in the positive electrode active material layers and deposited on the negative electrode is small. The batteries of the invention thus have good capacity recovery rates and can maintain the discharge characteristics.

When a porous film containing an inorganic oxide is in contact with an active material layer of a positive electrode or negative electrode, a polymer coating film of unsaturated sultone is evenly and uniformly formed in the pores of the porous film. Probably for this reason, lithium ions can be conducted smoothly and deterioration in initial rate characteristics can be suppressed. Also, the formed polymer coating film of unsaturated sultone can suppress deposition of the metal cations leached from the positive electrode during the high temperature storage onto the negative electrode. Probably for this reason, storage characteristics improve.

This is clear from a comparison between Examples 1 and 2, Comparative Examples 1, 3, and 4 containing no PRS, and Comparative Examples 1 and 2 having no porous film containing an inorganic oxide.

Also, a comparison between Example 1 and Example 2 shows that when the porous film containing the inorganic oxide is formed on the positive electrode active material layer surfaces, the initial capacity retention rate becomes higher. The reason is probably as follows. In the final stage of discharge, the decrease in lithium ions near the positive electrode becomes significant. Thus, when the polymer coating film of unsaturated sultone is evenly formed on the positive electrode surfaces, lithium ion conductivity at the interface between the electrolyte and the positive electrode improves, and deterioration in rate characteristics can be further suppressed.

### Example 3

Cylindrical non-aqueous electrolyte secondary batteries of the invention were produced and evaluated in the same manner as in Example 1, except that the presence or absence of the separator, the position of the porous film containing the inorganic oxide formed, and the porous film thickness were changed as shown in Table 2. The results are shown in Table 2.

In this example, each of the positive electrode active material layer and the negative electrode active material layer is formed on both sides of each of the positive electrode and the negative electrode in the thickness direction thereof. Hence, in the column “Position of porous film” in Table 2, for example, “Surfaces of positive electrode active material layers” means that the porous film was formed on each side of the positive electrode. Also, in “Position of porous film” and “Thickness of porous film” in Table 2, for example, “surfaces of separator, 5 μm” means that the porous film of 5 μm in thickness was formed on each side of the separator.

TABLE 2

| | | | Initial | Amount of metal | Capacity |
|---|---|---|---|---|---|
| | | | capacity | deposition | recovery |
| Presence or | Porous film | | retention | after | rate after |
| absence of | | Thickness | rate | storage | storage |
| separator | Position | (μm) | (%) | (μg/g) | (%) |
| Present | Surfaces of separator | 5 | 91.5 | 6.5 | 81.0 |
| | Positive-electrode- | 5 | 92.2 | 6.3 | 82.2 |
| | side surface of | | | | |
| | separator | | | | |
| | Negative-electrode- | 5 | 91.8 | 6.1 | 81.5 |
| | side surface of | | | | |
| | separator | | | | |
| | Surfaces of positive | 5 | 95.5 | 6.2 | 86.8 |
| | electrode active | | | | |
| | material layers | | | | |
| | Surfaces of negative | 5 | 93.0 | 6.4 | 84.0 |
| | electrode active | | | | |
| | material layers | | | | |
| Absent | Surfaces of positive | 25 | 95.0 | 6.4 | 86.1 |
| | electrode active | | | | |
| | material layers | | | | |
| | Surfaces of negative | 25 | 93.7 | 6.5 | 83.6 |
| | electrode active | | | | |
| | material layers | | | | |

In Example 3, in any of the batteries, the initial capacity retention rate was good, the amount of metal deposited on the negative electrode after the storage was reduced, and the capacity recovery rate after the storage was good.

In particular, the formation of the porous films containing the inorganic oxide on the positive electrode or negative electrode permitted further improvements in initial characteristic (capacity retention rate) and storage characteristic (capacity recovery rate), compared with the formation of the porous film on the separator. The reason is probably as follows. When the porous film containing the inorganic oxide is disposed on the separator, the inorganic oxide enters the pores of the separator and interferes with the passage of lithium ions therethrough, which results in slight deterioration in discharge characteristics.

Even when the battery included no separator, the porous films containing the inorganic oxide disposed between the positive electrode and the negative electrode allowed the battery to have excellent storage characteristics. This indicates that the porous film containing the inorganic oxide can also serve as an insulating film which prevents a short-circuit between the positive electrode and the negative electrode in the same manner as the separator.

### Example 4

Cylindrical non-aqueous electrolyte batteries of the invention were produced and evaluated in the same manner as in Example 1, except that LiPF₆ and/or LiBETI were/was used as the solute(s) of the non-aqueous electrolyte at concentrations shown in Table 3. The results are shown in Table 3. The total concentration of the solutes (lithium salts) in the non-aqueous electrolyte was set to 1 mol/L.

TABLE 3

| | | | | Amount of | Capacity |
|---|---|---|---|---|---|
| | | | | metal | recovery |
| | LiPF₆ | LiBETI | Initial | deposition | rate |
| | concen- | concen- | capacity | after | after |
| | tration | tration | retention | storage | storage |
| | (mol/L) | (mol/L) | rate (%) | (μg/g) | (%) |
| Example 4 | 1.0 | 0 | 95.5 | 6.2 | 86.8 |
| | 0.75 | 0.25 | 95.5 | 5.5 | 87.7 |
| | 0.5 | 0.5 | 95.3 | 5.1 | 89.5 |
| | 0.25 | 0.75 | 95.3 | 4.9 | 90.4 |
| | 0 | 1.0 | 95.1 | 4.8 | 90.1 |

Table 3 indicates that when LiBETI is used singly or in combination as a lithium salt in a battery including a non-aqueous electrolyte which contains PRS and a porous film containing an inorganic oxide, the amount of metal deposited on the negative electrode of the battery after storage is further reduced, and that the capacity recovery rate after storage is further improved. Since LiBETI can also serve as a surfactant, it increases the wettability of the non-aqueous electrolyte by the binder contained in the porous film, thereby making a local voltage rise unlikely to occur in the electrode. Probably for this reason, the amount of metal cation leaching was reduced. Also, when LiBETI itself is reduced at the negative electrode, it forms a good inorganic coating film such as LiF. Probably for this reason, it was possible to suppress deposition of the metal cations leached from the positive electrode onto the negative electrode.

### Example 5

LiPF₆ was dissolved in sulfolane at 1 mol/L. This solution was mixed with 2 parts by mass of PRS per 100 parts by mass of sulfolane. Further, fluoroethylene carbonate (hereinafter abbreviated as “FEC”) was added thereto at parts by mass shown in Table 4 per 100 parts by mass of sulfolane, to prepare non-aqueous electrolytes. Cylindrical non-aqueous electrolyte batteries of the invention were produced and evaluated in the same manner as in Example 1 except for the use of these non-aqueous electrolytes. The results are shown in Table 4.

TABLE 4

| | | | | Amount of | |
|---|---|---|---|---|---|
| | Amount of | Amount of | Initial | metal | Capacity |
| | PRS used | FEC used | capacity | deposition | recovery rate |
| | (part by | (part by | retention | after storage | after storage |
| | mass) | mass) | rate (%) | (μg/g) | (%) |
| Exam- | 2 | 0 | 95.5 | 6.2 | 86.8 |
| ple 5 | 2 | 1 | 95.4 | 5.7 | 87.7 |
| | 2 | 2 | 95.5 | 5.1 | 89.0 |
| | 2 | 5 | 95.4 | 4.6 | 90.5 |
| | 2 | 10 | 93.0 | 4.2 | 87.7 |

Table 4 indicates that when FEC is added to a non-aqueous electrolyte containing PRS in a battery including a porous film containing an inorganic oxide, the amount of metal deposited on the negative electrode of the battery after storage is further reduced, and that the capacity recovery rate after storage is further improved. FEC has a high wettability by the binder contained in the porous film. Thus, even when only a small amount is added, a local voltage rise is unlikely to occur in the electrode. Probably for this reason, the amount of metal cation leaching can be reduced. Also, when FEC is reduced at the negative electrode, it forms a good coating film. Probably for this reason, it is possible to suppress deposition of the metal cations leached from the positive electrode onto the negative electrode.

### INDUSTRIAL APPLICABILITY

The invention can provide a non-aqueous electrolyte secondary battery having excellent storage characteristics while maintaining the initial rate characteristics. In particular, it is possible to suppress deterioration in the rate characteristics of the battery after storage at a high temperature. The non-aqueous electrolyte secondary battery of the invention can be advantageously used, for example, as the power source for various devices, in the same manner as conventional non-aqueous electrolyte lithium batteries.

1-6. (canceled)

7. A non-aqueous electrolyte secondary battery comprising:
a positive electrode including a transition metal oxide capable of absorbing and desorbing lithium ions;
a negative electrode capable of absorbing and desorbing lithium ions;
an insulating film disposed between the positive electrode and the negative electrode, the insulating film being a polyamide film or a porous film containing an inorganic oxide; and
a non-aqueous electrolyte containing an unsaturated sultone.

8. The non-aqueous electrolyte secondary battery in accordance with claim 7, wherein the insulating film is formed on at least one of a surface of the positive electrode and a surface of the negative electrode.

9. The non-aqueous electrolyte secondary battery in accordance with claim 7, wherein the insulating film is formed on a surface of the positive electrode.

10. The non-aqueous electrolyte secondary battery in accordance with claim 7, further including a separator, wherein the separator is a porous resin sheet.

11. The non-aqueous electrolyte secondary battery in accordance with claim 7,
wherein the non-aqueous electrolyte contains lithium salts as solutes, and at least one of the lithium salts is lithium bispentafluoroethanesulfonyl imide.

12. The non-aqueous electrolyte secondary battery in accordance with claim 7, wherein the non-aqueous electrolyte contains a non-aqueous solvent as a solvent component, and the non-aqueous electrolyte further contains fluoroethylene carbonate in addition to the non-aqueous solvent.
